(19) United States
(12) Patent Application Publication
(10) Pub. No.: US 2018/0371258 A1
(43) Pub. Date: Dec. 27, 2018

(54) USE OF CERTAIN (PER)FLUOROPOLYETHER POLYMERS DERIATIVES AS ADDITIVES IN CLEAR-COATING COMPOSITIONS

(71) Applicant: SOLVAY SPECIALTY POLYMERS ITALY S.P.A., Bollate (IT)

(72) Inventors: Silvia Rita PETRICCI, Bresso (IT); Giovanni SIMEONE, Solaro (IT); Antonio PUPPO, Senago (IT)

(73) Assignee: SOLVAY SPECIALTY POLYMERS ITALY S.P.A., Bollate (IT)

(21) Appl. No.: 16/065,679

(22) PCT Filed: Dec. 21, 2016
(86) PCT No.: PCT/EP2016/082095

§ 371 Date: Jun. 22, 2018

(30) Foreign Application Priority Data
Dec. 22, 2015 (EP) 15201937.8

(51) Int. Cl. C09D 4/06; C09D 5/00; C09D 133/14

(52) U.S. Cl. CPC C09D 4/06; C09D 133/14; C09D 5/00

(57) ABSTRACT

The present invention relates to the use of (per)fluoropolyether polymer derivatives comprising acrylate moieties as additive in solvent-based formulations for coating substrates, notably glass, metal and plastic. In addition, the present invention further relates to certain novel (per)fluoropolyether polymer derivatives comprising acrylate moieties.

### CROSS REFERENCE TO RELATED APPLICATIONS

This application claims priority from European application No. 15201937.8 filed on 22 Dec. 2015, the whole content of this application being incorporated herein by reference for all purposes.

### TECHNICAL FIELD

The present invention relates to the use of (per)fluoropolyether polymer derivatives comprising acrylate moieties as additives in compositions for clear-coating.

### BACKGROUND ART

In the automotive industry, multi-layer coatings are used that typically comprise a cathodic e-coating, which protects from corrosion and provides a basis for applying the subsequent paint layers; a primer, which allows to provide a smoother surface and protects from UV-radiation, heat differences and stone-chipping; a base coat layer, which is a colour- and/or special effect-imparting base coat layer and contains the visual properties of colour end effects; and an outer clear coat layer, that forms the final interface with the environment.

The clear coat has both a decorative and a protective function, enhancing the shine and durability of the base coat layer, and at the same time it must provide specific properties to the substrate, including notable resistance to abrasion, easy-to clean and anti-fingerprint properties.

Easy-to-clean coating compositions have been developed in the art, exhibiting good initial self-cleanability due to a surface enrichment of hydrophobic substances in the coating layer, as disclosed for example in U.S. Pat. No. 5,597,874 (E.I. DU PONT DE NEMOURS AND COMPANY), U.S. Pat. No. 5,705,276 (E.I. DU PONT DI NEMOURS AND COMPANY) and US 2014/0364542 (AXALTA COATING SYSTEM IP CO., LLC).

US 2011/0293943 (E.I. DU PONT DE NEMOURS AND COMPANY) discloses a composition comprising a fluoropolymer and its use as an additive to coating compositions such as alkyd paints or polymeric resins, to provide durable surface effects. In particular, the compositions disclosed in this patent application comprise solvent-based fluoroalkyl (meth)acrylate copolymers with short (per)fluoroalkyl groups of 6 or less carbon atoms, notably from 2 to 6 carbon atoms. When used as an additive to a coating base, which is a solvent-based paint, the fluoropolymer composition of the invention is generally added at about 0.001 wt. % to about 1 wt. % on a dry weight basis of the fluoropolymer of the weight of the wet paint, more preferably from about 0.01 wt. % to about 0.5 wt. %.

Thus, this patent document discloses neither a composition comprising the polymers according to the present invention in the claimed amount, nor that the polymers can be used as additives in clear-coating compositions.

Fluorinated polymers comprising (per)fluoroalkyl groups and (meth)acrylic groups have been already disclosed in the art. For example, WO 2005/101466 A (UNIVERSITY OF NORTH CAROLINA) relates to coating compositions comprising a reactive fluorinated copolymer and an amino resin, the fluorinated copolymer having pendant perfluoropolyether groups and pendant groups capable of reacting with the amino resin.

EP 0394927 B (AUSIMONT S.P.A.) discloses a process for preparing methacrylates of fluorinated alcohols. EP 0622353 B (AUSIMONT S.P.A.) discloses coatings obtained with monofunctional PFPE polymers comprising one alkoxylated group and a terminal (meth)acrylic group, obtained by copolymerization of a monomer (a) having general formula:

YCF₂OR_{f}CFXCH₂(OCH₂CH₂)ₚOCOCR═CH₂

wherein Y is F, Cl, a perfluoroalkyl group having from 1 to 4 carbon atoms; X is F, CF₃; p is an integer from 1 to 5; Rf represents a radical having perlfuoropolyetheral structure; and R is H, CH₃.

In addition, WO 2010/094661 A (SOLVAY SOLEXIS S.P.A.) discloses a curable perfluoropolyether composition to be used in a nanolithography process, said composition comprising at least one functional PFPE compounds having at least two unsaturated moieties, said functional PFPE compound being the major component of said composition.

However, none of the abovementioned patent documents discloses a composition comprising the polymers according to the present invention in the claimed amount, and even more none of them discloses any advantages in terms of transparency of the coating.

EP 1995260 A (DAIKIN INDUSTRIES, LTD.) discloses a high energy ray-curable compositions containing (A) 100 parts by weight of a polyfunctional acrylate, (B) 1-30 parts by weight of an organoalkoxysilane having an aliphatic unsaturated bond, (C) 1-100 parts by weight of colloidal silica and (D) 0.2-20 parts by weight of a fluorine compound having an aliphatic unsaturated bond.

JP 2012/250353 (MITSUBISHI RAYON CO.) discloses a composition comprising a tetrafunctional or more (meth)acrylate (A1), a perfluoropolyether (meth)acrylate (B1), an organic solvent (C1) and a photopolymerization initiator (D1), said composition being curable via UV and being such to provide a coating film.

WO 2009/069974 (LG CHEMICAL LTD.) discloses a coating composition and a coating film that comprises a binder containing a UV-curable functional group, a compound containing a fluorine UV-curable functional group, a photoinitiator and nano-sized particles.

CN 1025004625 (HEFEI LUCKY SCI & TECH IND CO.—BAODING LUCKY FILM CO. LTD.) discloses an anti-pollution fingerprint transparent cured film, coated onto a support such to obtain a transparent hard coat layer. The film is obtained from a compositions comprising a UV acryl oligomer, a polyfunctional acrylic UV monomer, a photoinitiator, a modified perfluoropolyether, a leveling agent; and a solvent.

### SUMMARY OF INVENTION

The Applicant faced the problem to provide coating compositions for substrates, including metal, glass and plastic substrates, which provides a transparent coating together with outstanding water- and oil-repellency, easy to clean and stain removal properties, as well as anti-fingerprint performances.

The Applicant has surprisingly found that when certain (per)fluoropolyether (PFPE) polymers are used as additives in said compositions, substrates having the abovementioned desired properties can be obtained.

Thus, in a first aspect, the present invention relates to a method for providing a transparent coating onto at least one surface of a substrate, preferably selected from plastic, metal or glass, said method comprising:

(i) contacting at least one surface of a substrate with a composition [composition S] comprising:

A) from 0.01 to less than 5 wt. %, preferably from 0.05 to 4 wt. % and even more preferably from 0.1 to 2.5 wt. %, based on the total weight of said composition, of at least one (per)fluoropolyether polymer [polymer (P)] comprising at least one (per)fluoropolyoxyalkylene chain [chain R_{pf}] having two chain ends, wherein at least one chain end comprises at least one unsaturated moiety [moiety U];

B) from 50 to 99.99 wt. % of at least one UV-curable component, based on the total weight of said composition;

C) optionally further ingredients; and

(ii) curing said composition (S) onto said surface of a substrate.

In a second aspect, the present invention relates to the use of said composition (S) as defined above for coating at least one surface of a substrate, said substrate being preferably selected from glass, plastic and metal.

Advantageously, the coating obtained with said polymer (P) according to the present invention provides outstanding water- and oil-repellence, easy to clean and stain removal properties, as well as anti-fingerprint performances to the substrate onto which it is applied, while being transparent (i.e. clear).

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural from, depending on the context;
the term “(per)fluoropolyether” is intended to indicate fully or partially fluorinated polyether;
the terms “clear” and “transparent” are used as synonyms.

Preferably, said chain (R_{pf}) is a chain of formula

—O-D-(CFX^{#})_{z1}—O(R_{f})(CFX*)_{z2}-D*-O—

wherein

z1 and z2, equal or different from each other, are equal to or higher than 1;

X^{#} and X*, equal or different from each other, are —F or —CF₃, provided that when z1 and/or z2 are higher than 1, X^{#} and X* are —F;
D and D*, equal or different from each other, are an alkylene chain comprising from 1 to 6 and even more preferably from 1 to 3 carbon atoms, said alkyl chain being optionally substituted with at least one perfluoroalkyl group comprising from 1 to 3 carbon atoms;

(R_{f}) comprises, preferably consists of, repeating units R^{◯}, said repeating units being independently selected from the group consisting of:

(i) —CFXO—, wherein X is F or CF₃;

(ii) —CFXCFXO—, wherein X, equal or different at each occurrence, is F or CF₃, with the proviso that at least one of X is —F;

(iii) —CF₂CF₂CW₂O—, wherein each of W, equal or different from each other, are F, Cl, H;

(iv) —CF₂CF₂CF₂CF₂O—;

(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂ O—, —CF₂CF₂CF₂CF₂O—, with each of X being independently F or CF₃ and T being a C1-C3 perfluoroalkyl group.

Preferably, z1 and z2, equal or different from each other, are from 1 to 10, more preferably from 1 to 6 and even more preferably from 1 to 3.

More preferably, D and D*, equal or different from each other, are a chain of formula —CH₂—, —CH₂CH₂— or —CH(CF₃)—.

Preferably, chain (R_{f}) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}-I)

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ₁(CF₂O)ₐ₂]— (R_{f}-IIA)

wherein:
a1 and a2 are independently integers≥0 such that the number average molecular weight is between 400 and 10,000, preferably between 400 and 5,000; both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}(CF₂CF(CF₃)O)_{b4}]— (R_{f}-IIB)

wherein:

b1, b2, b3, b4, are independently integers≥0 such that the number average molecular weight is between 400 and 10,000, preferably between 400 and 5,000; preferably b1 is 0, b2, b3, b4 are ≥0, with the ratio b4/(b2+b3) being ≥1;

—[(CF₂CF₂O)_{c1}(CF₂O)_{c2}(CF₂(CF₂)_{cw}CF₂O)_{c3}]— (R_{f}-IIC)

wherein:

cw=1 or 2;

c1, c2, and c3 are independently integers≥0 chosen so that the number average molecular weight is between 400 and 10,000, preferably between 400 and 5,000; preferably c1, c2 and c3 are all ≥0, with the ratio c3/(c1+c2) being generally lower than 0.2;

—[(CF₂CF(CF₃)O)_{d}]— (R_{f}-IID)

wherein:

d is an integer>0 such that the number average molecular weight is between 400 and 10,000, preferably between 400 and 5,000;

—[(CF₂CF₂C(Hal*)₂O)ₑ₁—(CF₂CF₂CH₂O)ₑ₂—(CF₂CF₂CH(Hal*)O)ₑ₃]— (R_{f}-IIE)

wherein:
Hal*, equal or different at each occurrence, is a halogen selected from fluorine and chlorine atoms, preferably a fluorine atom;
e1, e2, and e3, equal to or different from each other, are independently integers≥0 such that the (e1+e2+e3) sum is comprised between 2 and 300.

Still more preferably, chain (R_{f}) complies with formula (R_{f}-III) here below:

—[(CF₂CF₂O)ₐ₁(CF₂O)ₐ₂]— (R_{f}-III)

wherein:
a1, and a2 are integers>0 such that the number average molecular weight is between 400 and 10,000, preferably between 400 and 5,000, with the ratio a1/a2 being generally comprised between 0.1 and 10, more preferably between 0.2 and 5.

Said moiety U is preferably selected in the group consisting of:

—C(═O)—CR_{H}═CH₂ (U-I)

—C(═O)—NH—CO—CR_{H}═CH₂ (U-III)

—C(═O)—R^{A}—CR_{H}═CH₂ (U-III)

wherein

R_{H} is H or a C1-C6 alkyl group;

R^{A} is selected from the group consisting of (R^{A}-I) and (R^{A}-II):

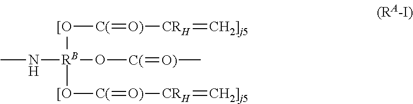

wherein

each of j5 is independently 0 or 1 and

R^{B} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S;

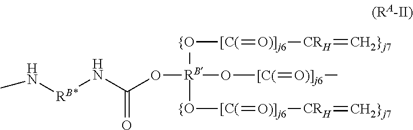

wherein

j6 is 0 or 1;

each of j7 is independently 0 or 1;

R^{B′} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S; and

R^{B*} has the same meanings defined above for R^{B′} or it is a group of formula (R^{B}-I):

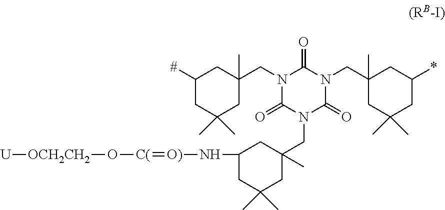

wherein

U is selected from the groups (U-I) to (U-III) as defined above and * and # indicate the bonding site to the nitrogen atoms in formula (R^{A}-II) above.

Preferably, said at least one moiety U is bonded to said chain (R_{pf}) via a sigma bond or via a (poly)oxyalkylene chain [chain (Rₐ)] comprising from 1 to 50 fluorine-free oxyalkylene units, said units being the same or different each other and being selected from —CH₂CH(J)O—, wherein J is independently selected from hydrogen atom, straight or branched alkyl or aryl, preferably hydrogen atom, methyl, ethyl or phenyl.

Preferably, chain (Rₐ) comprises from 2 to 50, more preferably from 3 to 40, even more preferably from 4 to 7 fluorine-free oxyalkylene units as defined above.

More preferably, said chain (Rₐ) is selected from:

—(CH₂CH₂O)ⱼ₁— (Ra-I)

—[CH₂CH(CH₃)O]ⱼ₂— (Ra-III)

—[(CH₂CH₂O)ⱼ₃—(CH₂CH(CH₃)O)ⱼ₄]ⱼ₍ₓ₎— (Ra-III)

wherein

j1 and j2, each independently, are an integer from 1 to 50, preferably from 2 to 50, more preferably from 3 to 40, even more preferably from 4 to 15, and still more preferably from 4 to 7;

j3, j4 and j(x) are integers higher than 1, such that the sum of j3 and j4 is from 2 to 50, more preferably from 3 to 40, even more preferably from 4 to 15, and still more preferably from 4 to 7.

When present, the recurring units having j*1 and j*2 as indexes can be either randomly distributed or they can be arranged to form blocks.

Advantageously, said polymer P comprises at least one chain [chain R_{pf}] and at least two unsaturated moieties [moieties U] as defined above, more preferably from 2 to 6 moieties U, and even more preferably from 2 to 4 moieties U.

More preferably, said at least two moieties U are bonded to opposite sides of said chain R_{pf}.

Preferred polymers P according to the present invention comprise:
one chain (R_{pf}) and
from 2 to 4 moieties U complying with formulae (U-I), (U-II) or (U-III) as defined above,

wherein said moieties U are bonded to said chain (R_{pf}) via a sigma bond or a chain (Rₐ) of formula —(CH₂CH₂O)ⱼ₁— wherein j1 is an integer from 4 to 7.

Preferred polymers (P) comply with the following formulae (P-I) to (P-III):

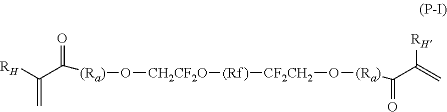

wherein

(R_{f}) is as defined above;

(Rₐ) is a chain of formula —(CH₂CH₂O)ⱼ₁— wherein j1 is an integer from 4 to 7; and

R_{H} and R_{H′}, equal or different from each other, are independently H or a C₁-C₆ alkyl group;

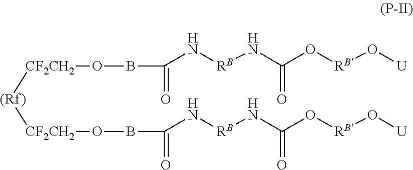

wherein

(R_{f}), R^{B} and R^{B′} have the same meaning as above detailed and B is a sigma bond or chain (Rₐ) as defined above.

Most preferred polymers (P) are selected from the group consisting of:

CH₂═CR_{H}—(O═)C—(OCH₂CH₂)ⱼ₁—OCH₂CF₂(CF₂CF₂O)ₐ₁(CF₂O)ₐ₂—CF₂CH₂O—(CH₂CH₂O)ⱼ₁—C(═O)—CR_{H}═CH₂ (P-i)

wherein

wherein R_{H} is hydrogen or methyl,

a1 and a2 are as defined above; and

each of j1 is independently an integer from 4 to 7;

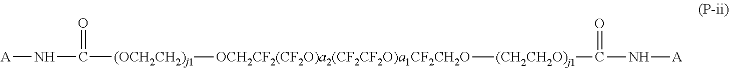

wherein

a1 and a2 are as defined above;

each of j1 is an integer from 4 to 7; and

each A is a group of formula

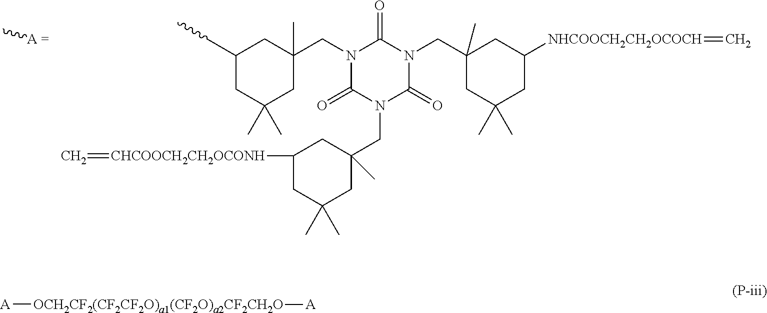

wherein

a1 and a2 are as defined above and

each A is a group of formula

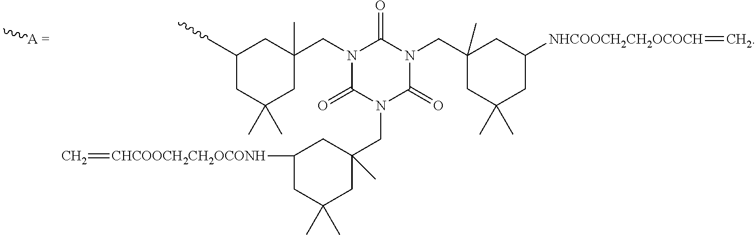

Polymer (P-iii) above is commercially available from Solvay Specialty Polymers Italy S.p.A. as Fluorolink® AD1700 PFPE.

Polymers P comprising one or more chain(s) (Rₐ) can be advantageously prepared starting from (poly)alkoxylated (per)fluoropolyether polymers [polymer P*],

which comprise at least one (per)fluoropolyoxyalkylene chain [chain (R_{pf})] having two chain ends [end (Rₑ)],

wherein at least one end (Rₑ) comprises a hydroxy-terminated (poly)oxyalkylene chain (R_{a*}) comprising from 1 to 50 fluorine-free oxyalkylene units, said units being the same or different each other and being selected from —CH₂CH(J)O— wherein J is independently selected from hydrogen atom, straight or branched alkyl or aryl, preferably hydrogen atom, methyl, ethyl or phenyl; and

the other end (Rₑ) bears a hydroxy-terminated (poly)oxyalkylene chain (R_{a*}) as defined above or is a neutral group selected from —CF₃, —C₂F₅, —C₃F₇, —CF₂Cl, —CF₂CF₂Cl and —C₃F₆Cl.

When only one of said ends (Rₑ) comprises a hydroxy-terminated (poly)oxyalkylene chain (R_{a*}) and the other end (Rₑ) bears a neutral group as defined above, the polymer is also referred to as “monofunctional polymer P*”.

When both said ends (Rₑ) comprises a hydroxy-terminated (poly)oxyalkylene chain (R_{a*}), the polymer is also referred to as “bifunctional polymer P*”. Preferably, the functionality of the bifunctional polymer P*, i.e. the number of —OH groups, is at least equal to 1.80, more preferably at least equal to 1.85 and still more preferably at least equal to 1.94. The functionality (F) can be calculated for example as disclosed in EP 1810987 A (SOLVAY SOLEXIS S.P.A.).

Said chain (R_{pf}) is as defined above. In a preferred embodiment, said chain (R_{pf}) comprises chain (R_{f}) complying with formula (R_{f}-III) as defined above.

Preferably, said ends (Rₑ) comply with the following general formulae (Rₑ-I) to (Rₑ-III):

—(CH₂CH₂O)ⱼ₁—H (Rₑ-I)

—(CH₂CH(CH₃)O)ⱼ₂—H (Rₑ-II)

—[(CH₂CH₂O)ⱼ₃(CH₂CH(CH₃)O)ⱼ₄]ⱼ₍ₓ₎—H (Rₑ-III)

wherein

j1 and j2, each independently, are an integer from 1 to 50, preferably from 2 to 50, more preferably from 3 to 40, even more preferably from 4 to 15, and still more preferably from 4 to 7;

j3, j4 and j(x) are integers higher than 1, such that the sum of j3 and j4 is from 2 to 50, more preferably from 3 to 40, even more preferably from 4 to 15, and still more preferably from 4 to 7.

More preferably, both said chain ends (Rₑ) comply with formulae (Rₑ-I) to (Rₑ-III) as defined above. Even more preferably, both ends (Rₑ) comply with formulae (Rₑ-I) as defined above.

Polymers P* are commercially available from Solvay Specialty Polymers (Italy) and can be obtained according to the method disclosed in WO 2014/090649 (SOLVAY SPECIALTY POLYMERS ITALY S.P.A.).

Polymers (P) comprising moiety(ies) U of formula (U-I), (U-II) and (U-III) wherein R^{A} is selected from the groups of formula (R^{A}-I) or (R^{A}-II) wherein R^{B} is different from the group of formula (R^{B}-I), can be advantageously prepared by a process comprising:

(a*) reacting at least one polymer P* as defined above with at least one compound comprising at least one α,β-unsaturated carbonyl group [compound (α,β)].

Suitable examples of said compounds (α,β) are those having the following general formulae:

X—C(O)—CR_{H}═CH₂

X—C(O)—NH—C(O)—CR_{H}═CH₂ and

X—C(O)—R^{A}—CR_{H}═CH₂

wherein

X is halogen atom, preferably Cl,

R_{H} has the same meaning defined above, more preferably it is hydrogen or methyl,

R^{A} has the same meaning defined above, except that in formula (R^{A}-II) R^{B} is different from group (R^{B}-I), more preferably R^{B} is a divalent or trivalent group selected from C₁-C₆ alkyl chain, C₅-C₇ cycloaliphatic group, C₆ aromatic group, optionally comprising at least one heteroatom selected from N, O and S.

Preferred compounds (α,β) are acryloyl chloride, methacryloyl chloride and the like.

Preferably, step (a*) is performed in the presence of a suitable organic solvent, such as for example hydrofluoroethers, hexafluoroxylene, and chloro-hydrocarbons.

Preferably, step (a*) is performed in the presence of a primary or secondary amine compound, such as for example di-isopropylamine, triethylamine and pyridine.

Preferably, step (a*) is performed at a temperature of from 5 to 40° C., more preferably from 15 to 30° C.

Polymers (P) comprising moiety(ies) U of formula (U-III) wherein R^{A} is the group of formula (R^{A}-II) wherein R^{B} is the group of formula (R^{B}-I) can be advantageously prepared by a process comprising:

(a**) reacting at least one diisocyanate compound with a compound [compound CU*] bearing at least one unsaturated moiety of formula (U-III) wherein R^{A} is the group of formula (R^{A}-II) as defined above and R^{B} is the group of formula (R^{B}-I) or at least one unsaturated moiety of formula (U-V); and

(b**) reacting the intermediate obtained in step (a) with at least one (per)fluoropolyether polymer P* as defined above.

Suitable diisocyanate compounds include for example aliphatic and aromatic isocyanate, such as isophoronediisocyanate (IPDI), hexamethylene diisocyanate (HDI), isomers of methylene-bis(cyclohexyl isocyanate) [also referred to as hydrogenated MDI] and mixtures thereof, isomers of methylene diphenyl diisocyanate (MDI) such as 2,2′-MDI, 2,4′-MDI and 4,4′-MDI and mixtures thereof, isomers of toluene diisocyanate (TDI) such as 2,4-TDI and 2,6-TDI, and mixtures thereof. Isophoronediisocyanate is particularly preferred.

Preferably, said compound CU* is selected from hydroxy-[C₁-C₆ alkyl]-acrylate derivatives, notably hydroxyethylacrylate, hydroxymethylacrylate, hydroxypropylacrylate; and alkyl-vinyl-ethers, notably ethylene glycol vinyl ether.

Preferably, step (a**) is performed in the presence of a suitable organic solvent, such as for example butyl acetate, ethyl acetate and mixtures thereof.

Preferably, step (a**) is performed in the presence of a catalyst, more preferably selected from tertiary amines, such as tryethylendiamine, N-ethyl-ethylene-imine, tetramethylguanidine; organotin compounds, such as for example dibutyltin dioctanoate and dibutyltin-dilaurate. Good results have been obtained by using dibutyltin-dilaurate.

Said catalyst are used in an amount not higher than 0.5 wt. % based on the total weight of the reaction mixture.

Preferably, step (a**) is performed using butylated-hydroxytoluene.

Preferably, step (a**) is performed under heating at a temperature of from 35° C. to 100° C. Preferably, heating is performed until the mixture turns limpid. The skilled person can determine the duration of the heating depending on the starting materials and on the reaction conditions.

Preferably, step (b**) is performed in the presence of an organic solvent such as ethyl acetate, butyl acetate and mixtures thereof.

Preferably, step (b**) is performed under heating at a temperature of from 40° C. to 100° C. Preferably, heating is performed until the mixture turns limpid. The skilled person can determine the duration of the heating depending on the starting materials and on the reaction conditions.

Polymer (P) can be used as such or a composition [composition (Si)], containing polymer (P) and a solvent can be prepared. Preferably, said composition (Si) is in the form of a solution. Suitable solvents are for example, ketones for instance methylethylketone (MEK), methylisobutylketone (MIBK); esters for instance ethyl acetate, butyl acetate, isobutyl acetate; organic solvents containing in the molecule an ester-ether group such as polyoxyethylene monoethyl-ether acetate, polyoxyethylene monobutylether acetate, polyoxy butylene mono-ethyl-ether acetate, polyoxy-butylene monobutylether acetate, polyoxyethylene diacetate, polyoxybutylene-diacetate, 2-ethoxy ethylacetate, ethyleneglycol diacetate, butyleneglycol diacetate. Esters are particularly preferred. Good results have been obtained by using butyl acetate, ethyl acetate and mixtures thereof.

Preferably, said composition (Si) contains polymer (P) in an amount of from 50 to 90 wt. % based on the total weight of said composition (Si).

Preferably, in composition (S), said UV-curable component comprises at least one solvent and a coating base selected from alkyd resins that are branched and cross-linked polyesters containing unsaturated aliphatic acid residues), urethane compounds obtained from the reaction of polyisocyanate and polyhydric alcohol esters of drying oil acids, and polyester compounds.

Suitable further ingredients are selected for example in the group comprising cross-linkers, transparent fillers, photo-initiators, volatile or non-volatile additives, for example selected from binders, catalysts, leveling agents, wetting agents, anticratering agents, dyes, rheology control agents, antioxidants and/or light stabilizers.

Suitable cross-linker agents include for example trans-esterification cross-linking agents, amino resin cross-linking agents, such as melamine-formaldehyde resins; trisalkoxycarbonylaminotriazine cross-linking agents, and the like.

Suitable transparent fillers include for example silica, more preferably nano-silica.

Each of said additional ingredient and additive is preferably used in conventional amounts, such as for example in an amount up to 8 wt. %, more preferably from 0.01 to 5 wt. % based on the total weight of composition (S).

Composition (S) can be advantageously prepared by contacting composition (Si) as defined above with a base coating composition [composition S*] comprising at least one UV-curable component as defined above and optionally mixing.

Advantageously, the amount of said composition (Si) is such that the final composition (S) contains an amount of polymer (P) of from 0.01 to less than 5 wt. %, based on the total weight of composition (S).

Said step (i) of contacting can be performed for example at room temperature. More elaborate contacting or mixing methods can be employed, which require for example the use of a mechanical shaker or heating.

Composition (S) can be applied to the surface of a suitable substrate to form a clear (i.e. transparent) coating layer.

Preferably, a suitable substrate is selected from the group comprising, preferably consisting of, glass; metal, including aluminium, optionally coated with a base coat layer, such as a pigmented base coat layer; and plastic, including polycarbonate (PC), polyvinyl chloride (PVC), thermoplastic olefin (TPO), thermoplastic polyurethane (TPU), polypropylene (PP), acrylonitrile butadiene styrene (ABS) and polyamides (PA).

Said pigmented base-coat layer can be cured, partially cured or uncured and represents the colours and/or special effect-imparting coating layer.

More preferably, said substrate is suitable to be used in the automotive industry for the interior and/or the exterior of vehicles, notably cars. Automotive substrates include in particular car windows and mirrors, automotive bodies and automotive metal or plastic parts. Examples of automotive bodies include truck and vehicle bodies, such as passenger car bodies and van bodies. Examples of automotive body metal or plastic parts can include doors, bonnets, boot lids, hatchbacks, wings, spoilers, bumpers, collision protection strips, slide trim, sills, mirror housing, door handles and hubcaps.

Preferably, step (i) is performed by traditional methods, such as for example spraying said composition (S) onto said at least one surface.

Typically, the film obtained after the spray step has a thickness of from 5 to 500 μm, more preferably from 10 to 250 μm, and even more preferably from 25 to 175 μm.

Preferably, step (ii) is performed by UV-curing composition (S) onto said at least one surface.

The curing conditions depend on the ingredients of said composition (S) and from the circumstances under which the coating and curing process is carried out.

Any source of radiation can be used. The radiation does can be adjusted by the skilled persons as a function of the composition (S) that is used. Good results have been obtained by applying a radiation of from 200 to 750 W. Preferably, when said step of curing is performed using UV, the curing time is from 1 to 50 seconds, more preferably from 5 to 30 seconds.

Should the disclosure of any patents, patent applications and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### EXPERIMENTAL SECTION

Materials

SR256: 2-(2-ethoxyethoxy) ethyl acrylate—slightly water dispersible, monofunctional monomer which acts as a reactive diluent (obtained from Sartomer)

CN9210: hexafunctional aliphatic urethan acrylate (obtained from Sartomer)

DESMODUR® Z4400—isophorone-diisocyanate (IPDI) trimer in methoxypropyl acetate/xylene (obtained from Bayer AG)

Darocur® 1173—2-hydroxy-2-methyl-1-phenyl-propan-1-one—liquid photoinitiator (obtained from CIBA)

Fluorolink AD1700® PFPE (Polymer P-1) solution of a perfluoropolyether (PFPE)-urethane acrylate in a mixture of ethyl acetate and butyl acetate (1:1 by weight)—was obtained from Solvay Specialty Polymers Italy S.p.A.

Synthesis

Polymer P-2

74.6 g (0.100 moles) of DESMODUR® Z4400, 47 g of ethyl acetate, 32 g of butyl acetate, 0.052 g of dibutyltin-dilaurate, 0.02 g of butylated hydroxytoluene were charged, under nitrogen atmosphere, into a 500 cc reactor equipped with stirrer, thermometer and falling cooler.

24.4 (0.21 moles) of hydroxyethylacrylate were slowly heated in half an hour at 50° C. The mixture was then heated at 70° C. and kept at this temperature for 3 hours.

84.94 g (0.039 moles) of Fomblin® of formula

HO(CH₂CH₂O)ₙCH₂CF₂O(CF₂CF₂O)ₐ₁(CF₂O)ₐ₂CF₂CH₂(OCH₂CH₂)ₙOH

having

average number molecular weight=2050,

a1/a2=1.36 and

n=4.5 as average

were loaded in an hour at 70° C. The mixture, initially lacteous, was kept at this temperature for 6 hours obtaining a solution having 70% by weight of product of formula

A-NH—(O═)C—(OCH₂CH₂)_{4.5}(R_{pf})(CH₂CH₂O)_{4.5}—OC(═O)—NH-A

wherein

R_{pf} is a chain of formula —OCH₂CF₂(CF₂CF₂O)ₐ₁(CF₂O)ₐ₂CF₂CH₂O— and

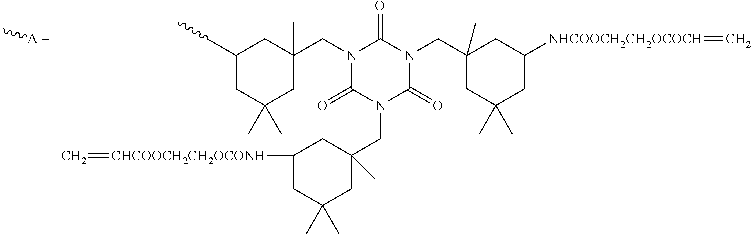

Polymer P-3

Under a nitrogen stream, 10.9 g (0.01 eq.) of hydroxy-terminated PFPE of formula

HO(CH₂CH₂O)ₙCH₂CF₂O(CF₂CF₂O)ₐ₁(CF₂O)ₐ₂CF₂CH₂(OCH₂CH₂)ₙOH

having

average number molecular weight=2050,

a1/a2=1.36 and

n=4.5 as average

are dissolved in 6 ml of hexafluoroxylene and then 1.61 g (0.013 eq.) of di-isopropylamine are added. The solution is stirred for 30 minutes at room temperature, then 1.08 g (0.012 mol) of acryloyl chloride are added dropwise in an ice bath. After completion of the reaction as monitored by ¹H-NMR, the reaction solution is distilled under vacuum to remove the hexafluoroxylene, the product is washed with distilled water (twice, using 50 ml each time), dried with anhydrous MgSO₄ and filtered to give 11.0 g (99% yield) of the final compound as a slightly yellow liquid

H₂C═CH—(O═)C—(OCH₂CH₂)_{4.5}(R_{pf})(CH₂CH₂O)_{4.5}—C(═O)—CH═CH₂

wherein

R_{pf} is a chain of formula —OCH₂CF₂(CF₂CF₂O)ₐ₁(CF₂O)ₐ₂CF₂CH₂O—.

### Example 1

1a—Preparation of the Polyacrylic-Based Formulation

5.0 g of SR256 and 5.0 g of CN9210 were mixed under stirring at room temperature for 15 minutes. Then, 0.2 g of Darocur® 1173 were added (Composition 1*).

Each of Polymers P-1 and P-2 was added to Composition 1* in suitable amounts, so as to obtain Compositions 2 and 3 having the additive concentration as indicated in Table 1.

1b—Preparation of Coated Support Using Polyacrylic Formulations

Each of Composition 2 and 3 prepared in Example 1a was applied with a doctor blade on three different supports: glass (G), aluminium panel (Al) and polycarbonate (PC), so as to obtain a wet film thickness of 100 microns.

Then, the coatings were UV cured using a UV lamp 500 W and exposition time of 15 seconds. The resulting dry film thickness was 50 microns.

Static contact angle values vs. water and vs. n-hexadecane were measured using con DSA30 (Kriss GmbH, Germany) equipment.

The haziness of the coating on glass was evaluated by visual inspection.

The results are reported in Table 1.

### Example 2—Easy Cleanability Testing

A staining agent (black marker type Pentel N50) was put on the surface of the different coated supports prepared following the procedure described in Examples 1b, for 24 hours at room temperature.

The results are showed in Table 1.

The results show that the dark stain was easily removed using a dry paper sheet in case of coatings prepared using formulations according to the present invention, wherein a PFPE was used as additive. Differently, an indelible stain was observed when coatings were prepared using the comparative formulations (formulation 1*) free of a PFPE additive.

TABLE 1

| | | | | | | SCA vs. | | | | |
|---|---|---|---|---|---|---|---|---|---|---|
| | Additive | | SCA vs. water | | | hexadecane | | | Glass | |
| Composition | | % | (degree °) | | | (degree °) | | | coating | Stain |
| No. | Polymer | w/w | G | Al | PC | G | Al | PC | aspect | test |
| 1(*) | — | — | 58 | 66 | n/p | 20 | 25 | 20 | clear | − |
| 2 | P-1 | 2.0 | 101 | 101 | n/p | 56 | 64 | n/p | clear | ++ |
| 3 | P-1 | 1.0 | 106 | 106 | 108 | 56 | 60 | 69 | clear | ++ |
| 4 | P-1 | 0.5 | 103 | 105 | 105 | 61 | 59 | 58 | clear | ++ |
| 5 | P-2 | 1 | 80 | 90 | n/p | 57 | 64 | n/p | clear | ++ |
| 6 | P-3 | 0.5 | 99 | n/p | n/p | 70 | n/p | n/p | clear | ++ |

(*)comparative
G = glass
Al = aluminium
PC = polycarbonate
n/p = not performed
In the stain test:
− indicated stain
+ indicated halo
++ indicated no stain.

### Example 3—Easy Cleanability Testing on Fingerprints

The anti-fingerprint test was carried out in accordance to the method MIL C 15074E by using synthetic sebum commercially available (Scientific Services S/D Inc.), having the following composition (wherein the amounts are given as w/w %):

Palmitic Acid (10%),

Stearic Acid (5%),

Coconut Oil (15%),

Paraffin Wax (10%),

Synthetic Spermacetti (15%),

Olive Oil (20%),

Squalene (5%),

Cholesterol (5%),

Oleic Acid (10%) and

Linoleic Acid (5%).

The procedure was as follows. Different black polycarbonate (PC) coated supports were prepared following the procedure described in Example 1b. A folded cotton bandage (size 30×30 mm) was wetted with synthetic sebum (after melting the composition in oven at 40° C. and shaking before use) and applied on the black PC coated support for 10 seconds, applying a load of 1 kg. Then the black PC coated support was put in oven for 60 minutes at 40° C.

A dry paper sheet was used to clean the fingerprint stain. The results are summarized in Table 2.

TABLE 2

| Composition No. | Anti-fingerprint test |
|---|---|
| 1(*) | − |
| 3 | ++ |

(*)comparative
In the stain test:
− stain
+ halo
++ no stain

The results showed that the fingerprint stain was easily removed from the coating obtained using the composition containing the PFPE polymer as additive, while stain remained and was observed on the coating obtained used the comparative composition 1(*).

1. A method for providing a transparent coating onto at least one surface of a substrate, preferably selected from plastic, metal or glass, said method comprising:
(i) contacting at least one surface of a substrate with a composition (S), wherein composition (S) comprises:
A) from 0.01 to less than 5 wt. %, based on the total weight of said composition, of at least one (per)fluoropolyether polymer (P) comprising at least one (per)fluoropolyoxyalkylene chain (R_{pf}) having two chain ends, wherein at least one chain end comprises at least one unsaturated moiety U;
B) from 50 to 99.99 wt. % of at least one UV-curable component, based on the total weight of said composition;
C) optionally further ingredients; and
(ii) curing said composition (S) onto said surface of the substrate.

2. The method according to claim 1, wherein chain (R_{pf}) is a chain of formula
—O-D-(CFX^{#})_{z1}—O(R_{f})(CFX*)_{z2}-D-O—
wherein
z1 and z2, equal or different from each other, are equal to or higher than 1;
X^{#} and X*, equal or different from each other, are —F or —CF₃,
provided that when z1 and/or z2 are higher than 1, then X^{#} and X* are —F;
D and D*, equal or different from each other, are divalent alkyl chains comprising from 1 to 20 carbon atoms, said alkyl chain being optionally interrupted by at least one oxygen atom and/or optionally substituted with at least one hydroxy group and/or with a perfluoroalkyl group comprising from 1 to 3 carbon atoms; and
(R_{f}) comprises repeating units R^{◯}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, is F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, and —CF₂CF₂CF₂CF₂O—, with each of X being independently F or CF₃ and T being a C₁-C₃ perfluoroalkyl group.

3. The method according to claim 1, wherein moiety U is selected from the group consisting of:
—C(═O)—CR_{H}═CH₂, (U-I)
—C(═O)—NH—CO—CR_{H}═CH₂, and (U-II)
—C(═O)—R^{A}—CR_{H}═CH₂, (U-III)
wherein
R_{H} is H or a C₁-C₆ alkyl group;
R^{A} is selected from the group consisting of (R^{A}-I) and (R^{A}-II): 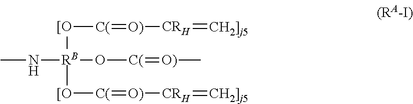
wherein
each of j5 is independently 0 or 1 and
R^{B} is a divalent, trivalent or tetravalent group selected from the group consisting of C₁-C₁₀ aliphatic groups; C₃-C₁₂ cycloaliphatic groups; and C₅-C₁₄ aromatic or alkylaromatic groups, optionally comprising at least one heteroatom selected from N, O and S; 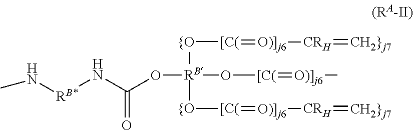
wherein
j6 is 0 or 1;
each of j7 is independently 0 or 1;
R^{B′} is a divalent, trivalent or tetravalent group selected from the group consisting of C₁-C₁₀ aliphatic groups; C₃-C₁₂ cycloaliphatic groups; and C₅-C₁₄ aromatic or alkylaromatic groups, optionally comprising at least one heteroatom selected from N, O and S; and
R^{B*} has the same meanings defined above for R^{B′} or is a group of formula (R^{B}-I): 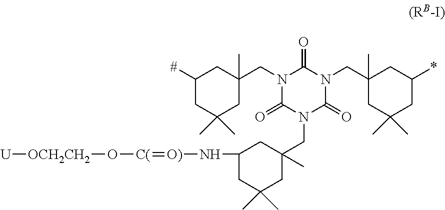
wherein U is selected from the groups (U-I) to (U-III) as defined above and
and # indicate the bonding site to the nitrogen atoms in formula (R^{A}-II) above.

4. The method according to claim 1, wherein said at least one moiety U is bonded to chain (R_{pf}) via a sigma bond or via a (poly)oxyalkylene chain (Rₐ) comprising from 1 to 50 fluorine-free oxyalkylene units, said units being the same or different each other and being selected from —CH₂CH(J)O—, wherein J is independently selected from a hydrogen atom, and straight or branched alkyl or aryl groups.

5. The method according to claim 1, wherein polymer P comprises at least one chain (R_{pf}) and at least two unsaturated moieties (U).

6. The method according to claim 1, wherein said chain (Rₐ) comprises from 2 to 50 fluorine-free oxyalkylene units as defined above.

7. The method according to claim 6, wherein chain (Rₐ) is selected from:
—(CH₂CH₂O)ⱼ₁— (Rₐ-I)
—[CH₂CH(CH₃)O]ⱼ₂— (Rₐ-II)
—[(CH₂CH₂O)ⱼ₃—(CH₂CH(CH₃)O)ⱼ₄]ⱼ₍ₓ₎— (Rₐ-III)
wherein
j1 and j2, each independently, are an integer from 1 to 50;
j3, j4 and j(x) are integers higher than 1, such that the sum of j3 and j4 is from 2 to 50.

8. The method according to claim 3, wherein polymer P comprises:
one chain (R_{pf}) and
from 2 to 4 moieties U complying with formulae (U-I), (U-II) or (U-III),
wherein said moieties U are bonded to said chain (R_{pf}) via a sigma bond or a chain (Rₐ) of formula —(CH₂CH₂O)ⱼ₁— wherein j1 is an integer from 4 to 7.

9. The method according to claim 1, wherein said UV-curable component comprises at least one solvent and a coating base selected from alkyd resins that are branched and cross-linked polyesters containing unsaturated aliphatic acid residues, urethane compounds obtained from the reaction of polyisocyanate and polyhydric alcohol esters of drying oil acids, and polyester compounds.

10. The method according to claim 1, wherein said further ingredients are selected from the group consisting of cross-linkers, transparent fillers, photo-initiators, volatile or non-volatile additives, binders, catalysts, leveling agents, wetting agents, anticratering agents, dyes, rheology control agents, antioxidants and/or light stabilizers.

11. The method according to claim 10, wherein each of said further ingredients is present in composition (S) in an amount up to 8 wt. % based on the total weight of composition (S).

12. The method according to claim 1, wherein said substrate is selected from the group consisting of glass; metal optionally coated with a base coat layer; and plastic.

13. The method according to claim 1, wherein step (i) is performed by spraying said composition (S) onto said at least one surface.

14. The method according to claim 1, wherein step (ii) is performed by UV-curing composition (S) onto said at least one surface.

15. The method according to claim 1, wherein composition (S) comprises:
A) 0.1 to 2.5 wt. %, based on the total weight of said composition, of the at least one (per)fluoropolyether polymer (P);
B) from 50 to 99.99 wt. % of the at least one UV-curable component, based on the total weight of said composition; and
C) optionally further ingredients.

16. The method according to claim 2, wherein D and D*, equal or different from each other, are divalent alkyl chains comprising from 1 to 3 carbon atoms, said alkyl chain being optionally interrupted by at least one oxygen atom and/or optionally substituted with at least one hydroxy group and/or with a perfluoroalkyl group comprising from 1 to 3 carbon atoms.

17. The method according to claim 6, wherein said chain (Rₐ) comprises from 4 to 7 fluorine-free oxyalkylene units as defined above.

18. The method according to claim 11, wherein each of said further ingredients is present in composition (S) in an amount from 0.01 to 5 wt. % based on the total weight of composition (S).

19. The method according to claim 12, wherein the metal substrate is aluminium, optionally coated with a pigmented base coat layer.

20. The method according to claim 12, wherein the plastic substrate is selected from the group consisting of polycarbonate (PC), polyvinyl chloride (PVC), thermoplastic olefin (TPO), thermoplastic polyurethane (TPU), polypropylene (PP), acrylonitrile butadiene styrene (ABS), polyamides (PA) and mixtures thereof.
